(19) United States
(12) Patent Application Publication
(10) Pub. No.: US 2025/0066519 A1
(43) Pub. Date: Feb. 27, 2025

(54) ANTIMICROBIAL RUBBER COMPOSITION AND ARTICLES MADE THEREFROM

(71) Applicant: GARWARE FULFLEX INDIA PVT LIMITED, Pune (IN)

(72) Inventor: Padmesh Jain, Pune (IN)

(21) Appl. No.: 18/454,375

(22) Filed: Aug. 23, 2023

(51) Int. Cl. C08F 136/08; C08K 3/06; C08K 3/08; C08K 3/22; C08K 3/26; C08K 3/36; C08K 5/09; C08K 5/39; C08K 5/43; C08K 5/47; C08L 9/06; C08L 71/02

(52) U.S. Cl. CPC C08F 136/08; C08K 3/06; C08K 3/08; C08K 3/22; C08K 3/26; C08K 3/36; C08K 5/09; C08K 5/39; C08K 5/43; C08K 5/47; C08L 9/06; C08L 71/02; C08K 2003/0806; C08K 2003/2241; C08K 2003/2296; C08K 2003/265; C08K 2201/005; C08K 2201/011; C08K 2201/019; C08L 2205/02

(57) ABSTRACT

A latex-free, sulphur-cured antimicrobial rubber composition and articles made therefrom is provided. The antimicrobial rubber composition includes at least one rubber constituent, colloidal silver nanoparticles, at least one filler, at least one accelerator, a curing agent, and at least one additive. Articles produced from the antimicrobial rubber composition have reduction rates for Staphylococcus aureus and Escherichia coli of at least 99.5% and 99.5% respectively.

### FIELD OF THE INVENTION

The present disclosure relates to antimicrobial rubber composition and articles made therefrom. In particular, the present disclosure relates to latex-free, sulphur-cured antimicrobial rubber composition and articles made therefrom.

### BACKGROUND

Antimicrobial agents have been incorporated into many different substrates for preventing and controlling the growth of microbes. However, with the continual introduction of new consumer products, there exists a constant demand in the marketplace for protection against bacterial and fungal growth presented by some of these new products. For instance, the dispensing mechanism in refrigerators that dispense water and ice present an ideal environment in the dispensing mechanism for the growth of microbes due to the moist environment. Because of its shape and location, it is often difficult for consumers to assess the interior portion of the dispensing mechanism so that a thorough cleaning can be conducted. As another example, front loading laundry machines provide an ideal environment for microbial growth in any of the water contact locations in the machine. One such location includes the circular door sealing gasket used to make a seal between the wash compartment and the glass door.

The growth and proliferation of microbes in machines generally occur from exposure to prolonged warm, moist environments which may contain various residues, dirt, and bacteria. This environment leads to the development of undesirable odor and biofilm. Biofilm is the growth of microbes, such as bacteria and fungi, on a surface commonly surrounded by an exopolymer matrix. Both the abundant microbial growth and matrix production results in visible microbial communities, thus damaging the aesthetic appeal of the surface. Various antimicrobial agents and compositions are known in the market which cater to the need of industrial machines and apparatuses.

In the context of surgical procedures and implements, the chance of infection due to minutely lower efficiency of the sterilization process for surgical implements is a well-known factor in causing post-procedure complications due to infection. Thus, it is advantageous to have antimicrobial properties in a surgical implement such as tourniquets and Esmarch bandage. Furthermore, the sterilization process becomes far more efficient when the initial bioburden of microorganisms kept to a minimum using an antimicrobial additive.

In this context, articles comprising natural rubber in majority amounts inhibiting the microbial growth is still a challenge. Rubber based articles are subject to numerous standards for safety, and one highly important and contentious topic is the use of latex or latex-containing rubber for medical products. Latex is the sap of the rubber tree, which drips out and is collected when the bark of the rubber tree is damaged. Latex is a complex emulsion consisting of proteins, alkaloids, starches, sugars, oils, tannins, resins, and gums that coagulate on exposure to air.

The natural purpose of latex is to seal wounds that the tree suffers and to ensure that no animals try to damage it further as well as well as preventing infection of the tree's wound. To that end, latex contains skin-irritating and naturally antimicrobial proteins, and these are carried over into latex products and those manufactured from dry natural rubber. The manufacturing process does not remove them, and they are well known to cause anaphylactic shocks, resulting in what commonly known as latex allergy. This may manifest as swelling of affected areas, reddening of affected area, skin rashes and blisters of varying intensity, and potentially extreme levels of discomfort. Extreme cases may require hospitalization, emergency measures and extended periods of treatment.

Most prominently used antimicrobial agents include silver and copper-based additives that contain the metals in widely known forms: elemental metals and ions. Copper is an elemental metal, whereas silver ions are popularly used as antimicrobial additives for various applications such as textile coatings, bathroom fittings, etc. Silver ions converted into additive form in several combinations, of which the most popular are silver zeolite salts and silver chromium-based complexes are known in the existing compositions. These are easy to add and are heat stable in the absence of chemicals and release silver ions into the rubber matrix during the curing reaction, thereby providing antimicrobial activity for as long as the silver ions remain there or are not degraded.

Certain types of antimicrobial peroxide-catalyst vulcanized rubber formulations have been produced in the past. It is well understood and accepted that silicone rubbers cannot be vulcanized by typical sulfur-based catalysts. Again, however, to date there have been no disclosures or suggestions of producing a non-silicone raw rubber composition or vulcanized rubber article exhibiting antimicrobial properties.

The sulphur-containing compounds when used as vulcanizers/curing agents react with silver ion-containing compounds to form silver sulfide, which chemically degrades these antimicrobial agents, thereby reducing their efficacy. Moreover, due to the sulphur-based curing system, silver ions from other antimicrobial additives also affect the curing characteristics of the rubber formulation, causing it to cure prematurely, known as “scorching”, as well as degrading the physical characteristics of the final rubber product. Furthermore, the resulting product obtained after curing the existing rubber composition using the sulfur-based curing agents have a higher tendency of discoloration.

Therefore, there is required an antimicrobial rubber composition and articles made therefrom that address at least the aforementioned problems.

### SUMMARY OF THE DISCLOSURE

An antimicrobial rubber composition comprises at least one rubber constituent, a colloidal silver nanoparticles component, at least one filler, at least one accelerator, a curing agent, and at least one additive.

A method of preparing an antimicrobial rubber composition includes blending a set of ingredients including at least one rubber constituent, a colloidal silver nanoparticles component, at least one filler, at least one accelerator, a curing agent, and at least one additive, and mixing the set of ingredients in an internal mixer or a rubber mill at temperatures ranging between 200° C. to 2000° C.

### DESCRIPTION OF THE DISCLOSURE

An aspect of the present disclosure relates to an antimicrobial rubber composition. In one embodiment, the antimicrobial rubber composition comprises:
(a) at least one rubber constituent,
(b) colloidal silver nanoparticles,
(c) at least one filler,
(d) at least one accelerator,
(e) a curing agent, and
(f) at least one additive.

In an embodiment, the antimicrobial rubber composition is latex free. In the present context, “latex free” refers to the antimicrobial rubber composition being devoid of latex or natural rubber. Said otherwise, the antimicrobial rubber composition can include any synthetic rubber material except latex or natural rubber.

In another embodiment, the antimicrobial rubber composition is devoid of any silicone-based rubber. In the present context, “silicone-based rubber” includes both natural and synthetic rubber like material containing at least one siloxane group.

In the present context, “rubber” is intended to cover any standard rubber which must be vulcanized to provide a dimensionally stable rubber article. The term “dimensionally stable” is intended to encompass a vulcanized rubber article that is structurally able to be handled without disintegrating into smaller portions. Thus, the article must exhibit some degree of structural integrity and being a rubber, a certain degree of flexural modulus. Suitable examples of the rubber constituent include, but are not limited to, synthetic polyisoprene, polybutadiene, copolymers of butadiene with styrene, also known as styrene-butadiene rubber (SBR) or acrylonitrile (NBR), butyl rubber, ethylene-propylene diene monomer rubber (EPDM), and blends of two or more of these.

In the present context, “colloidal silver nanoparticle” refers to stabilizing aqueous solution comprising silver nanoparticles. Silver must be added in colloidal nanoparticle form to create a bond in rubber matrix, which impart specific properties to the material. Colloidal silver nanoparticles solution exhibits an increase of absorption from 420 to 440 nm with increased starch quantity. In an embodiment, the silver nanoparticle has a particle size of less than 500 nm.

Colloidal silver nanoparticles are employed as suitable antimicrobial agents. In an embodiment, the silver nanoparticles are nanoparticles of silver, preferably as silver chloride. Silver nanoparticles may be synthesized using starch under sonication. Unlike the conventional silver-based antimicrobial agents, colloidal silver nanoparticles synthesized in this manner do not react with the curing agent. Moreover, these colloidal silver nanoparticles do not alter the processing of the rubber composition and provide the same benefits in terms of easy usage, low cost, and antimicrobial activity compared with the conventional antimicrobial agents.

Further, the use of colloidal silver nanoparticles does not cause scorching or premature curing of the rubber composition, thereby maintaining the physical characteristics of the final cured product. Moreover, since the colloidal silver nanoparticles are stabilized in a solution, they are not negatively affected by the presence of curing agents, particularly the sulfur-based curing agents. The colloidal silver nanoparticles release silver ions over a very long period. Hence, the article obtained from the rubber composition have antimicrobial properties for substantially longer periods as compared to the ones obtained using the existing compositions.

Suitable amounts of the colloidal silver nanoparticles in the present composition range between 0.001 wt. % to 5.0 wt. % based on the weight of the total composition.

Suitable fillers in the present composition include inorganic oxides such as, but not limited to, inorganic particulate or amorphous solid materials which possess either oxygen (chemisorbed or covalently bonded) or hydroxyl (bound or free) at an exposed surface such as but not limited to oxides of the metals in Periods 2, 3, 4, 5 and 6 of Groups Ib, IIb, IIIa, IIIb, IVa, IVb (except carbon), Va, VIa, VIIa and VIII of the Periodic Table of the Elements in Advanced Inorganic Chemistry: A Comprehensive Text by F. Albert Cotton et al., Fourth Edition, John Wiley and Sons, 1980. Non-limiting examples of inorganic oxides for use in the present invention can include precipitated silica, colloidal silica, silica gel, aluminum silicates, alumina, calcium carbonate and mixtures thereof. Suitable metal silicates can include a wide variety of materials known in the art, non-limiting examples include but are not limited to aluminum, magnesium, sodium, potassium silicate, and mixtures thereof.

In an embodiment, the fillers can be added in the present composition in an amount in between 1 wt. % to 70 wt. % based on the total weight of the composition. In another embodiment, it is desirable to maximize the amount of silica present in the composition in order to improve tensile strength and elongation. For example, it may be desirable to add silica in amounts greater than 30 wt. %, or greater than 40 wt. %.

In another embodiment, silica can be precipitated silica, colloidal silica, and mixtures thereof. The silica can have an average ultimate particle size of less than 0.1 micron, or from 0.01 to 0.05 micron, or from 0.015 to 0.02 micron, as measured by electron microscope. Further, the silica can have a surface area of from 25 g/m² to 1000 g/m² or from 75 g/m² to 250 g/m² or from 100 g/m² to 200 g/m². The surface area can be measured using conventional techniques known in the art. As used herein, the surface area is determined by, for example, the Brunauer, Emmett, and Teller (BET) method according to ASTM D1993-91.

Suitable accelerators can be selected from the group consisting of 2-mercaptiobezothiazole, 2-mercaptobenzothiazole disulfide, N-cyclohexyl-2-benzothiazolesulfenamide, zinc oxide, zinc dibenzyldithiocarbamate, zinc dibutyldithiocarbamate, zinc diethyldithiocarbamate, alkyl phenol disulfide polymers, N,N′-di-o-tolylguanidine, diphenyl guanidine, dipentamethylene thiuram, and other compounds in the category of sulfenamides, thiazoles, thiurams, metal thiocarbamates and salts, and guanidines.

Suitable curing agents for the present composition include sulfur-based curing agents. Unlike the state-of-the-art compositions employing a combination of sulfur-based curing agents and antimicrobial agents, in particular silver-based compounds, the present composition does not result in the activity of the antimicrobial agent getting adversely affected. This is attributed to the fact that the colloidal silver nanoparticles are not adversely affected by the sulfur-based curing agents, thereby resulting in far longer antimicrobial activity in the final product obtained using the present composition in comparison with the existing compositions. Moreover, despite the presence of sulfur-based curing agents, there is also no discoloration in the final product which is seen in the existing compositions. Furthermore, because the sulfur-based curing agents are more cost effective than other curing agents, the final product can be produced for less.

Suitable amounts of the curing agents in the present composition range between 0.001 wt. % to 5.0 wt. % based on the total weight of the composition.

In an embodiment, the present composition is devoid of any peroxide-based curing agents. Suitable examples of such peroxide-based curing agents include the likes of dicumyl peroxide, 2,5-bis(t-butylperoxy)-2,5-dimethylhexane, di-(t-butyl-peroxy-isopropyl)benzene, di-(t-butyl-peroxy-trimethyl)-cyclohexane, and inorganic peroxides.

The present composition also comprises additives such as, but not limited to, clays, talc, carbon black, and the like, oils, plasticizers, accelerators, antioxidants, heat stabilizers, light stabilizers, zone stabilizers, organic acids, such as stearic acid, benzoic acid, or salicylic acid, other activators, extenders, cure retarders such as N-(cyclohexylthio) phthalimide and coloring pigments. The compounding recipe selected will vary with the particular vulcanizate prepared. Such recipes are well known to those skilled in the art of rubber compounding.

Other additives and/or auxiliaries include accelerator activators, antidegradants, softeners, abrasives, colorants, flame retardants, homogenizing agents, internal lubricants, mold-releasing additives, perfumes, and odorants.

Another aspect of the present disclosure relates to a method for preparing the antimicrobial rubber composition, as described hereinabove.

In an embodiment, the method comprises at least the step of blending or mixing the aforementioned ingredients using suitable means. For example, the aforementioned ingredients can be mixed in an internal mixer or a rubber mill at temperatures ranging between 20° C. to 200° C.

In another embodiment, the method comprises at least the step of compounding the aforementioned ingredients in a vessel, for example in a batch-wise or continuous manner. The aforementioned ingredients can be added in any manner and can also be added all at once or partly into the vessel.

Another aspect of the present disclosure relates to an article comprising the antimicrobial rubber composition, as described hereinabove.

In an embodiment, the article can be used in any application, such as, but not limited to, medical related applications. For example, the article can be used for surgical hemostasis.

Hemostasis is a process to prevent and stop bleeding, meaning to keep blood within a damaged blood vessel. It is the first stage of wound healing. In an embodiment, the article can include tourniquets, Esmarch bandages, belts, pads, paddings, gauze, sleeves, patches, and similar.

By way of an example, the article can be used to expel venous blood from a limb, also referred as exsanguination. The limb is often elevated as the elastic pressure is applied. The exsanguination is necessary to enable some types of delicate reconstructive surgery where bleeding would obscure the working area. A bloodless area is also required to introduce local anesthetic agents for a regional nerve block. The article can be used for this purpose.

The article can have a suitable dimension such that it can easily fit on a body part. For example, the article can have a dimension ranging between 3 to 6 inches in breadth, 0.3 to 0.5 inches in thickness and 4 to 9 feet in length. Alternatively, the article can also be obtained from continuous sheets and/or rolls made from the composition and produced by suitable methods such as but not limited to calendaring. Subsequently, the sheets and/or rolls can be cut into desired dimensions.

In a preferred embodiment, the article is an Esmarch bandage and is based on rubber composition comprising the components, preferably in the following ranges given, shown in Table 1:

TABLE 1

| Component | Amount (g) |
|---|---|
| Cis-(1, 4) polyisoprene | 166-170 |
| Styrene-butadiene rubber | 30-32 |
| Zinc oxide | 6-7 |
| Butylated product of m-cresol | 1.8-2.2 |
| Stearic acid | 2.7-3.3 |
| Calcium carbonate | 22-25 |
| Titanium dioxide | 9.5-10.5 |
| Silica | 38-42 |
| Colloidal silver nanoparticles | 5.5-6.5 |
| Polyethylene glycol | 3.8-4.2 |
| 2-Mercaptobenzothiazole disulphide | 2.8-3.2 |
| Zinc dibenzyldithiocarbamate | 0.9-1.1 |
| Sulphur | 2.8-3.2 |
| N-(cyclohexylthio)phthalimide | 0.95-1.05 |

Advantageously, the present article possesses percentage reduction rates for Staphylococcus aureus and Escherichia coli of at least 99.5% and 99.5%, corresponding to log kill rates of at least 2, respectively after 24 hours from inoculation according to the testing protocol specified in the standard ISO 22196-Antibacterial Activity of Non-Porous Surfaces.

### Example

The following example is illustrative of the invention but not limitative of the scope thereof.

A series of rubber compositions containing different components were fabricated and tested for antibacterial activity to illustrate the effective antibacterial activity of the composition. The components listed in Table 1 were blended and cured using equipment and techniques well known in the rubber formulation art. Synthetic polyisoprene rubber and styrene-butadiene rubber were mixed in a Banbury mixer with the fillers, processing aids, antioxidants, and part of the cure package in the first pass to form a master batch. The components were mixed for 2 minutes or until the compound reached 115° C. In the second pass, the master batch was then fed into an open two-roll mill and sulfur was added and mixed for 5 minutes at 85° C.

An Esmarch bandage was produced by calendering the rubber composition in a two-roll calendar, using magnesium silicate powder, more commonly known as talc, to prevent the composition sticking to the rolls. The calendering process was carried out at a temperature of 90° C., with the composition temperature not exceeding 100° C. The composition was calendared to a thickness of 0.4 inches thick and 1180 mm wide. The composition was then cured in a hot-air curing chamber for 4.5 h, and then slit to the required width and cut to the required length.

Table 2 below provides the amounts in a control composition (Control 1), which is a non-antimicrobial Esmarch bandage composition, and in Example 1, which is a sulphur-cured antimicrobial Esmarch bandage using silver nanoparticle-based additive in accordance with the present invention.

TABLE 2

| | Control 1 | Example |
|---|---|---|
| Component | (in g) | 1 (in g) |
| Cis-(1, 4) polyisoprene | 173 | 168 |
| Styrene-butadiene rubber | 32 | 31 |
| Zinc oxide | 7 | 7 |
| Butylated product of m-cresol | 2 | 2 |
| Stearic acid | 3 | 3 |
| Calcium carbonate | 31 | 24 |
| Titanium dioxide | 10 | 10 |
| Silica | 33 | 40 |
| Colloidal silver nanoparticles | — | 6 |
| Polyethylene glycol | 4 | 4 |
| 2-Mercaptobenzothiazole disulphide | 3 | 3 |
| Zinc dibenzyldithiocarbamate | 1 | 1 |
| Sulphur | 3 | 3 |
| N-(cyclohexylthio)phthalimide | — | 1 |

The antibacterial activity was tested using methods described in the ISO 22196 and JIS 2801 standards. In comparison to the composition Control 1, the composition prepared from Example 1 showed a log kill rate of 3.93, corresponding to 99.98% reduction with Escherichia coli, and a log kill rate of 4, corresponding to 99.99% reduction in Staphylococcus aureus after 24 hr.

Exemplary embodiments have been disclosed above and illustrated in the accompanying drawings. It will be understood by those skilled in the art that various changes, omissions, and additions may be made to that which is specifically disclosed herein without departing from the spirit and scope of the present invention.

What is claimed is:

1. An antimicrobial rubber composition comprising:
at least one rubber constituent;
a colloidal silver nanoparticles component;
at least one filler;
at least one accelerator;
a curing agent; and
at least one additive.

2. The antimicrobial rubber composition of claim 1, wherein the antimicrobial rubber composition is latex free and is devoid of any peroxide-based curing agents.

3. The antimicrobial rubber composition of claim 1, wherein the at least one rubber constituent includes one or more components selected from the group consisting of synthetic polyisoprene, polybutadiene, copolymers of butadiene with styrene, butyl rubber, and ethylene-propylene diene monomer rubber (EPDM).

4. The antimicrobial rubber composition of claim 1, wherein the colloidal silver nanoparticles component includes silver nanoparticles with a particle size of less than 500 nm.

5. The antimicrobial rubber composition of claim 1, wherein the at least one filler is selected from the group consisting of precipitated silica, colloidal silica, silica gel, aluminum silicates, alumina, calcium carbonate aluminum, magnesium, sodium, potassium silicate, and mixtures thereof.

6. The antimicrobial rubber composition of claim 1, wherein the at least one accelerator is selected from the group consisting of 2-mercaptiobezothiazole, 2-mercaptobenzothiazole disulfide, N-cyclohexyl-2-benzothiazolesulfenamide, zinc oxide, zinc dibenzyldithiocarbamate, zinc dibutyldithiocarbamate, zinc diethyldithiocarbamate, alkyl phenol disulfide polymers, N,N′-di-o-tolylguanidine, diphenyl guanidine, dipentamethylene thiuram, and other compounds in a category including sulfenamides, thiazoles, thiurams, metal thiocarbamates and salts, and guanidines.

7. The antimicrobial rubber composition of claim 1, wherein the curing agent is a sulfur-based curing agent.

8. The antimicrobial rubber composition of claim 1, wherein the at least one additive is selected from the group consisting of clays, talc, carbon black, oils, plasticizers, accelerators, antioxidants, heat stabilizers, light stabilizers, zone stabilizers, organic acids, extenders, cure retarders such as N-(cyclohexylthio) phthalimide, coloring pigments, accelerator activators, antidegradants, softeners, abrasives, colorants, flame retardants, homogenizing agents, internal lubricants, mold-releasing additives, perfumes, and odorants.

9. The antimicrobial rubber composition of claim 1, wherein the colloidal silver nanoparticles component is between 0.001 wt. % to 5.0 wt. % of a total weight of the antimicrobial rubber composition.

10. The antimicrobial rubber composition of claim 1, wherein the fillers are between 1 wt. % to 70 wt. % of a total weight of the antimicrobial rubber composition.

11. The antimicrobial rubber composition of claim 1, wherein the curing agents are between 0.001 wt. % to 5.0 wt. % of a total weight of the antimicrobial rubber composition.

12. The antimicrobial rubber composition of claim 8, wherein the organic acids are selected from a group consisting of stearic acid, benzoic acid, and salicylic acid.

13. A method of preparing an antimicrobial rubber composition comprising:
blending a set of ingredients including at least one rubber constituent, a colloidal silver nanoparticles component, at least one filler, at least one accelerator, a curing agent, and at least one additive; and
mixing the set of ingredients in an internal mixer or a rubber mill at temperatures ranging between 200° C. to 2000° C.

14. The method of claim 13, wherein the blending the set of ingredients is done in a batch-wise manner.

15. The method of claim 13, wherein the blending the set of ingredients is done in a continuous manner.

16. The method of claim 13, further including producing an article from the antimicrobial rubber composition, wherein the article is selected from a group consisting of tourniquets, Esmarch bandages, belts, pads, paddings, gauze, sleeves, and patches.

17. The method of claim 13, the set of ingredients does not include any peroxide-based curing agents.
